(19) United States
(12) Patent Application Publication
(10) Pub. No.: US 2005/0176893 A1
(43) Pub. Date: Aug. 11, 2005

(54) Hydrophilic surface modifying macromolecules (H-phil SMM) and H-phil SMM blended membranes

(76) Inventors: Dipak Rana, Ottawa (CA); Takeshi Matsuura, Ottawa (CA); Roberto Martin Narbaitz, Ottawa (CA); Chaoyang Feng, Gatineau (CA); Hai Anh Nguyen, Ottawa (CA)

Correspondence Address: Ralph A. Dowell of DOWELL & DOWELL P.C., 2111 Eisenhower Ave., Suite 406, Alexandria, VA, 22314, US

(21) Appl. No.: 11/036,216

(22) Filed: Jan. 18, 2005

Related U.S. Application Data
(60) Provisional application No. 60/536,998, filed on Jan. 20, 2004.

(51) Int. Cl. C08F 2/00

(52) U.S. Cl. 525/242

(57) ABSTRACT

The present invention provides hydrophilic surface modifying macromolecules (H-phil SMM) and H-phil SMM and blended membranes produced incorporating the hydrophilic surface modifying macromolecules. The membranes include a hydrophilic base polymer, and the hydrophilic surface modifying macromolecules (H-phil SMM) which impart surface hydrophilic properties to the membrane. The membranes produced with the surface modifying macromolecules give polymer membranes useful in the separation of water from a solution containing volatile organic compounds and water.

### CROSS REFERENCE TO RELATED APPLICATIONS

This patent application claims the priority benefit from U.S. Provisional Patent Application Ser. No. 60/536,998 filed on Jan. 20, 2004 entitled HYDROPHILIC SURFACE MODIFYING MACROMOLECULES (H—PHIL SMM) AND H—PHIL SMM BLENDED MEMBRANES.

### FIELD OF THE INVENTION

The present invention relates generally to articles produced from polymer materials having modified surfaces, such as a hydrophobic polymer article having a hydrophilic surface due to migration of a miscible, hydrophilic component to the surface of the article. More particularly, the present invention relates to hydrophilic surface modifying macromolecules (H-phil SMM) and H-phil SMM blended membranes produced incorporating the hydrophilic surface modifying macromolecules.

### BACKGROUND OF THE INVENTION

Articles or products made of polymeric materials are indispensable in a large number of technologically and commercially-important areas such as coatings, membranes, medical devices industry and the like. The ability to control the surface chemistry of such polymeric articles is highly advantageous for many reasons. For example, a product or article may, for reasons of economics or synthesis convenience, be produced of a hydrophobic material while in certain application it may be desirable for the product to have a different type of surface, for example a hydrophilic surface. There are many well known methods for modifying surface properties of polymers, but many do not result in thermodynamically or physically-stable surfaces and may involve multi-step processes.

An important way of modifying polymer articles is to provide them with a surface of high surface tension (surface energy) relative to the article as a whole, which is advantageous in many applications since higher surface tension is usually equivalent with better wettability. In cases where this is achieved using polymer blends which include a higher surface energy component and a lower surface energy component the lower surface energy component (lower wettability component) tends to be present disproportionately at the surface since surface energy is characterized by inter-molecular attraction. In other words, thermodynamic considerations result in the component with the higher inter-molecular attraction residing below the surface where it can be surrounded by a larger number of like molecules, while the lower surface energy component resides at the surface where a molecule is inherently surrounded by fewer like molecules.

While there are methods for producing polymeric materials having higher surface tension constituents at the surface, such conventional methods are problematic in that there is a tendency of the surface to reorganize itself over time through chain reorientation where the lower surface tension component(s) migrate to the surface of the polymer resulting in an irreversible loss of desired surface properties.

In the particular case of acrylate polymers, the control of surface properties is of technological importance in many areas such as recording media, textiles, coatings, latex paints and biomedical devices just to mention a few. In this case the methods for modification of the acrylate polymer surface chemistry is typically achieved by kinetically governed processes that provide very little control over the final surface structure and composition. Chemical oxidation by acid treatment can produce pitting and solubilization that modifies surface morphology in an uncontrolled and undesirable manner (see Wu, Polymer Interface and Adhesion (Marcel Dekker, Inc., New York, 1982)). As disclosed in Pekna, et al., Biomaterials, 14, 189-192 (1993), grafting techniques used to bond hydrophilic species such as for example heparin or poly(ethylene glycol) to surfaces in order to improve biocompatibility usually yield low surface coverage. Plasma and flame treatments are typically used to oxygenate surfaces thereby improving wetting and/or adhesion. A drawback to this type of treatments is it can result in reaction cascades of bond fragmentation and crosslinking which can yield poorly-defined surface compositions.

Surface functionalization and modification is particularly important in polymer membrane technology. For example, the utilization of polymer membranes for water treatment has become very widespread in the past several decades, particularly in such applications as desalination of sea and brackish water, purification of industrial wastewater and production of ultrapure water. Membrane purification processes are routinely being used to generate ultrapure water sources for the electronics industry, and to treat wastewater from many industries including textiles, electroplating and metal finishing, petroleum and petrochemical, food and beverage to mention just a few. A major advantage associated with the use of membranes over conventional water treatment technologies is that they are inherently less energy-intensive than distillation methods used for desalination, since thermodynamically there is no phase change associated with the process. They can also be produced with selected pore sizes to filter for pollutants above a given pore size. In addition, membrane filtration units offer greater flexibility in the scale of operation compared to conventional water purification systems because of their modular and compact design.

However, current industrial membrane technology suffers from significant materials-related drawbacks that limit their lifetime, and hence cost-effectiveness in for example applications involving water treatment. A specific drawback in this area is membrane fouling which results in reduced efficiency due to low membrane lifetimes, throughput decline, high maintenance costs. While careful system operation and flow-pattern design can reduce fouling by suspended particulates or precipitated salts, the adsorption of proteins onto membrane surfaces is more insidious, generating a monolayer film that provides a foothold for slower deposition processes which deteriorate membrane performance and lifetime substantially. Membranes used in reverse osmosis processes have additional materials-related limitations. While the cellulose acetate-based membranes most commonly found in this application exhibit high flux and good salt rejection, these polymers hydrolyze over time, generating physical holes in the membrane which reduces its useful lifetime. Thus there is a need for new membrane materials with longer lifetimes and increased resistance against fouling. In addition, membranes with improved selectivity are desirable for efficient and cost-effective recovery of wastewater components.

Prior art methods of modifying hydrophobic membranes to impart hydrophilicity to the hydrophobic membrane surfaces have generally been centered on the grafting or coating of hydrophilic species directly onto membranes. This approach is problematic for several reasons, namely the grafted monolayers are prone to removal during membrane cleaning; the densities of grafted components are generally low due to kinetic limitations and the grafting reactions usually require an additional processing step and are difficult to scale up for commercially viable production.

An alternative approach with the potential to overcome these problems is the addition of a hydrophilic macromolecular component to the membrane material that congregates at the membrane surface during processing. Membrane materials prepared by this approach can offer important performance and processing advantages over commercial membrane materials as well as coated and graft-modified membranes. Unlike typical coated membranes, the surfaces of these membranes present an additive which is intimately entangled with the matrix. Furthermore, where segregation can be accomplished through a thermodynamic driving force, “self-healing” membranes are possible, whereby surface-active additive material removed from the membrane surface can be replaced by further segregation of the branched component, optionally during a periodic annealing operation. Finally, surface localization of the branched component can occur during the standard processing step, thus eliminating the need for additional membrane fabrication steps.

There are several known surface-modification methodologies disclosed in the patent literature. For example, U.S. Pat. No. 5,030,352 issued to Varady, et al. is directed to a method of modification of a hydrophobic solid phase with a block copolymer having hydrophobic and hydrophilic domains. The hydrophobic domains associate with the solid phase through hydrophobic-hydrophobic interaction, and the hydrophilic domains extend out away from the surface. The method includes the step of crosslinking the block copolymer in order to produce a hydrophilic surface coating masking hydrophobic regions of the solid phase.

U.S. Pat. No. 5,098,569 issued to Stedronsky, discloses a surface-modified membrane which has a modifying polymer adsorbed onto a surface of the membrane and uniformly crosslinked thereon.

U.S. Pat. Nos. 4,923,914, 5,120,888, 5,344,862, 5,494,855, and 5,057,262 issued to Nohr et al. are directed to thermoplastic compositions designed to expose a particular desired surface characteristic. Typically, Nohr, et al. employ a hydrophilic additive that is immiscible (incompatible) with the bulk polymeric component under ambient conditions, and therefore is driven to the surface of the blend upon solidification due to this incompatibility (via enthalpy). U.S. Pat. No. 5,494,855 describes blends including additives having good tensile properties or surface wettability. The low molecular weight additives are believed to migrate more readily in blends.

A block copolymer additive for modifying the surface of polymeric material is disclosed in U.S. Pat. No. 4,698,388 issued to Ohmura, et al. The block copolymer includes a matrix-compatible constituent and a constituent having a characteristic desirably present at the surface which is incompatible with the matrix. The surface-modifying portion of the block copolymer segregates to the surface region due to its incompatibility with the block copolymer while the compatible constituent interacts with the polymer matrix to retain the additive in the matrix.

U.S. Pat. No. 4,578,414 issued to Sawyer, et al. is directed to fine, wettable fibers and/or filaments prepared from olefin polymers in addition to a relatively short, polymeric wetting agent including a hydrophilic domain and a hydrophobic domain. The additive segregates such that the hydrophilic domain modifies the surface.

U.S. Pat. Nos. 5,079,272 and 5,158,721 issued to Allegrezza, et al. discloses a porous membrane including an interpenetrating polymer network of a hydrophobic polymer and an in-situ-crosslinked, interpenetrating hydrophilic polymer. The method includes the step of annealing the network in order to crystallize the hydrophobic component, thereby excluding the hydrophilic component to the surface.

U.S. Pat. No. 5,190,989 issued to Himori is directed to an AB-type block copolymer that includes both a hydrophilic group and a group having an affinity for a resin in which the hydrophilic component is oriented toward the surface of the resin.

U.S. Pat. No. 5,258,221 issued to Meirowitz, et al. is directed to a two-step process in which a surface of a hydrophobic polyolefin product is modified by contacting the surface with a copolymeric material above the glass transition temperature of the polyolefin product thereby fusing the copolymeric material to the polyolefin. In this process the copolymeric material comprises a hydrophobic moiety compatible with the polyolefin and a modifying (hydrophilic) moiety that is incompatible with the polyolefin.

U.S. Pat. No. 5,328,951 issued to Gardiner discloses a method for modifying the surface of an organic polymer-based material for increasing the surface energy of the material, specifically a polyolefin material, by forming a blend including a base polymer and an amphiphile. The amphiphile has a lipophilic component which is compatible with the base polymeric material, that is believed to bind the amphiphile in the base polymer, and a hydrophilic component less compatible with the polymeric base which is located at the surface of the article.

U.S. Pat. No. 5,494,855 issued to Matsuura et al. is directed to membranes including a relatively hydrophilic base polymer, and hydrophobic surface modifying macromolecules (SMM) which imparts surface hydrophilic properties to the membrane. The difference between the current invention and the above mentioned patent is that the current invention intends to render the surface more hydrophilic by adding hydrophilic SMMs, while hydrophobic SMMs were added in the earlier invention to render the surface more hydrophobic.

United States Patent Publication Serial No. 2002/0155311 A1 teaches an alternative method of preparing a hydrophilic surface on a hydrophobic polymer article through the addition of a hydrophilic species to the polymer which selectively segregates to the surface upon processing, thereby providing the desired surface hydrophilicity. Specifically, the surface modifying material is based on polymethacrylate and polyacrylate, and their derivatives with hydrophilic side chains. The base polymer is essentially polyacrylate while PVDF is also used as a host polymer. In this publication, surface migration is due to an entropy effect, by which the branched polymer will migrate to the surface and the pore size is controlled in the top surface layer by blending the surface modifying macromolecules.

The scientific literature describes several methods of surface modification of polymer articles. As reported by Nunes, et al., “Ultrafiltration Membranes From PVDF/PMMA Blends”, J. Membrane Sci., 73, 25-35, 1992; Ito, et al., “pH-Sensitive Gating by Conformational Change of a Polypeptide Brush Grafted onto a Porous Polymer Membrane”, J. Am. Chem. Soc., 119, 1619-1623 (1997), membranes from miscible blends of PVDF with from 5% to 34% poly(methyl methacrylate) (PMMA). They describe graft-polymerization of benzyl glutamate NCA onto a porous PTFE membrane, and report the results of a study of the effects of ionic strength and pH on permeation rates. The rate of water permeation through the membrane was found to be slower under high-pH conditions and faster under low-pH conditions since, under high-pH conditions, randomly coiled graft chains extended thereby acting to close the pores.

A method for attaching a chelating reagent, selective for Cu ²⁺ over Fe³⁺, to side chains of a polymer to produce a cation exchange membrane is disclosed in Kojima, et al., “Selective Permeation of Metal Ions Through Cation Exchange Membrane Carrying N-(8-quinolyl)-sulfonamide as a Chelating Ligand”, J. Membrane Sci., 102, 49-54 (1995). This polymer was impregnated into a porous Teflon matrix after being diluted in a solvent.

A method of grafting of 4-vinylpyridine onto polyethylene and polypropylene microfiltration membranes is disclosed in Mika, et al., “A New Class of Polyelectrolyte-Filled Microfiltration Membranes with Environmentally Controlled Porosity”, J. Membrane Sci., 108, 37-56 (1995). In this process the grafting is UV-induced and results in the modified membranes exhibiting a pH valve effect along with the capability of rejecting small inorganic ions in the presence of reverse osmosis.

A glow discharge method for grafting polyacrylamide and polyacrylic acid chains onto polyvinylidene fluoride (PVDF) membrane is disclosed in Iwata, et al. (“Preparation and Properties of Novel Environmental-Sensitive Membranes Prepared by Graft Polymerization Onto a Porus Membrane”, J. Membrane Sci., 38,185-199 (1988). The permeation rates and separation characteristics of membranes treated according to this method were found to vary significantly with pH and ionic strength of the feed solution, both of which influence the configurations of the grafted chains. It was found that variations in the ionic strength and pH of the feed solution vary the extent to which electrostatic forces between the charges along the grafted polyion chains are screened. For example, at low pH values, the negative charges along the grafted chains are heavily screened by positive counterions, and the chains adopt random coil like configurations. On the other hand, at higher pH values, the grafted chains are dissociated, and they adopt extended configurations due to electrostatic repulsion between the negative charges spaced along them, thereby blocking the pores.

A drawback of many prior techniques for modifying polymer surfaces is the durability of the modified surface and/or the optical and physical properties of the article may be deleteriously affected. For example, in the case when a surface modifying component is water-soluble, the component can become separated or disassociated from the polymer surface over time if the product is used in an aqueous environment and the surface modifying component is not securely bonded to the polymer article. In the case of polymer blends which utilize the incompatibility of a surface modifying component may be problematic in that they may be prone to the formation of micelles or other segregated grouping within the polymer, which can result in discoloration or cause the polymer to become opaque. Since incompatibility is the property necessary for segregation in many techniques, these techniques inherently carry these potential drawbacks.

The scientific literature describes studies of surface migration of components of a polymer blend based upon their architecture. Steiner, et al., Science, 258, 1126-1129 (1992) and Sikka, et al., Phys. Rev. Lett., 70, 307-310 (1993), discloses experiments on polyolefin blends which demonstrate that when components of the polymer blends are similar in energy, there is a tendency for the more highly-branched components to segregate at the surface of the article. However, there is some controversy in the literature in that Steiner, et al. (Supra) report that it is not clear that surface migration of the more highly-branched polyolefin occurs due to its architecture. Indeed, in these systems since the more branched component is the lower surface tension component the more branched component would be expected to reside at the surface according to the reported technique.

It would be very advantageous to provide a simple, inexpensive technique for producing thermodynamically-stable polymeric articles such as membranes having a desired surface property.

### SUMMARY OF THE INVENTION

Accordingly, it is an object of the present invention to provide a simple, inexpensive technique for generating thermodynamically-stable polymeric articles having a desired surface property. In particular, it is an object to provide a technique for generating thermodynamically-stable, relatively high-surface-energy surfaces on polymeric articles for a variety of purposes.

It is another object of the invention to provide stable hydrophilic surfaces on various polymers to improve anti-fouling properties of membranes made from the polymers, and to increase the wettability of the polymers. It is another object of the invention to provide straightforward techniques for creation of membranes of a variety of polymers having desired surface properties, and robust membranes having desired functionality in for example water purification applications.

In one aspect of the invention there is provided a macromolecule having a general formula:
C-{P₁-A-P₂-[B]ᵣ}_{q}-P₃-A-P₄-C
wherein a precursor for A is a hard segment component of the macromolecule and is a substituted or unsubstituted aromatic and/or aliphatic group having polar end groups, the precursor for [B]ᵣ is a soft segment polymer having polar end groups, the precursor for C is a hydrophilic oligomer having polar end groups, P₁, P₂, P₃ and P₄ are polar linking groups formed by reaction between the respective polar end groups of the precursor for A, [B]ᵣ and C, r is in a range of 1 to 10, q is in a range of 1 to 3 and a molecular weight of the [B]ᵣ group is in a range from about 200 to about 6000 Dalton.

In this aspect of the invention the precursor for the substituted or unsubstituted aromatic and/or aliphatic group A has polar end groups selected from the group consisting of isocyanate, hydroxy, amine, carboxylic acid and combinations thereof, and wherein the precursor for the soft segment polymer Br has polar end groups selected from the group consisting of hydroxy and amine groups.

In another aspect of the invention there is provided a macromolecule having a general formula:
C-{P₁-A-P₂-[B]ᵣ}_{q}-P₃-A-P₄-C
wherein A is a hard segment component of the macromolecule and is a substituted or unsubstituted aromatic and/or aliphatic group, [B]ᵣ is a soft segment polymer, C is a hydrophilic oligomer, P₁, P₂, P₃ and P₄ are polar linking groups, r is in a range from 1 to 10, q is in a range from 1 to 3 and a molecular weight of the [B]ᵣ is in a range from about 200 to about 6000 Dalton.

In another embodiment of the present invention there is provided a method of synthesizing a macromolecule (I) having a general formula: C-{P₁-A-P₂-[B]ᵣ}_{q}-P₃-A-P₄-C C wherein A is a hard segment component of the macromolecule and a precursor for A is a substituted or unsubstituted aromatic and/or aliphatic group having polar end groups, a precursor for Br is a soft segment polymer having polar end groups, and a precursor for C is a hydrophilic oligomer having polar end groups, and P₁, P₂, P₃ and P₄ are polar linking groups formed by reaction between the respective polar end groups of the precursors for A, Br and C, r is in a range of 1 to 10, q is in a range of 1 to 3 and the molecular weight of the [B]ᵣ group is in the range of about 200 to about 6000 Dalton, the method comprising the steps of:
synthesizing a segmented block oligomeric copolymer {P-A-P-[B]ᵣ}_{q}, by reacting a substituted or unsubstituted aromatic and/or aliphatic having end isocyanate, hydroxy, amine or carboxylic acid groups with an oligomeric diol having end hydroxy or amine groups to form a urethane, amide, ester or urea linkage; and
reacting the segmented block oligomeric copolymer {P-A-P-[B]ᵣ}_{q}, with a hydrophilic oligomer to end cap the segmented block oligomeric copolymer to produce macromolecule (I).

The present invention also provides a macromolecule having a formula (I) 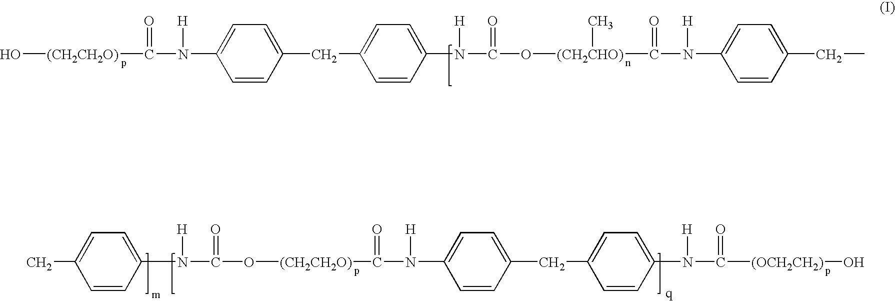
which is poly(4,4′-diphenylenemethylene propylene-urethane)-co-poly(4,4′-diphenylene methylene ethylene-urethane) both ends capped by polyethylene glycol.

The present invention also provides a macromolecule having a formula (II) 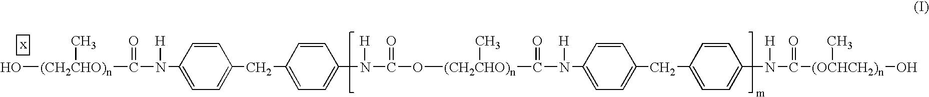
which is poly(4,4′-diphenylenemethylene propylene-urethane) having both ends capped with polypropylene glycol.

In accordance with the invention, a membrane for the separation of water is provided, the membrane comprising:
a) between about 10 to about 25 wt % of a hydrophobic base polymer miscible with a macromolecule mixed therewith, the macromolecule having a general formula C-{P₁-A-P₂-[B]ᵣ}_{q}-P₃-A-P₄-C, wherein A is a hard segment component of the macromolecule and is a substituted or unsubstituted aromatic and/or aliphatic group, [B]ᵣ is a soft segment polymer, C is a hydrophilic oligomer, P₁, P₂, P₃ and P₄ are polar linking groups, r is in a range from 1 to 10, q is in a range from 1 to 3 and a molecular weight of the [B]ᵣ is in a range from about 200 to about 6000 Dalton; and
b) between about 0 to about 20 wt % of a hydrophilic pore forming polymer miscible with the base polymer and from about 49 to about 90 wt % of a solvent, the solvent being subsequently eliminated from the membrane by either an evaporation or a solvent exchange process or a combination of the evaporation and solvent exchange process.

In various embodiments of the invention, the polar linkages P₁, P₂, P₃ and P₄ are preferably urethane linkages but may also be amide, ester or urea. Preferably, {P₁-A-P₂-[B]ᵣ}_{q}, a segmented block oligomeric copolymer, is formed by the reaction of a substituted or unsubstituted aromatic and/or aliphatic having end isocyanate, hydroxy, amine or carboxylic acid groups with a soft segment polymer having end hydroxy or amine groups to form a urethane, amide, ester or urea linkage. In particular embodiments, the precursor hard segment isocyanates can be selected from any one of the group methylene di-phenylene 4,4′-diisocyanate (MDI), toluene 2,4-diisocyanate, toluene 2,6-diisocyanate, cyclohexane 1,4-diisocyanate, methylene di-cyclohexane 4,4′-diisocyanate or hexane 1,6-diisocyanate as well as other diisocyanates known to those skilled in the science of polyurethane chemistry. The precursor soft segment polymer can be selected from any one of polypropylene oxide polyols, polytetramethylene oxide polyol, polyalkylene oxide polyol, polycarbonate polyol, polyester polyol or polycaprolactone polyol.

End capping the segmented block oligomeric copolymer above is achieved by reaction with any of the following oligomeric compounds. Any one of the polyols stated above, polyalkylene amines, aromatic or aliphatic polyamide with either a carboxy or amine end group or both. The examples are 1) polyethylene glycol 2) polyethylenimine 3) 1,4-phenylene diamine, phthalic acid copolymer. 1-10 would be most appropriate as the number of repeat units in an oligomer.

In still further embodiments, the base polymer is selected from any one of or a combination of polyethersulfones, polyureas, polyetherimides, polyesters, polyurethanes, polycarbonates or polyvinylidene fluoride and the pore forming polymer is selected from any one of a combination of polyvinylpyrrolidone (PVP), ethylene glycol, alcohols, polyethylene glycol.

The membrane in accordance with the invention enables the separation of water from organic solvent by pervaporation and provides a permeation rate of water through their membrane of 0.01-10 kg/m² hr. The membrane in accordance with the invention enables also the separation of water soluble electrolytes and sugars by nanofiltration with a water flux of 10 to 50 kg/m² hr by nanofiltration at 150 psig and macromolecular solutes, proteins, colloidal particles by ultrafiltration with a water flux of 10 to several hundred kg/M² hr at 50 psig.

Still further, the membrane in accordance with the invention is characterized by an advancing contact angle by at least 3 degrees less than that of the base membrane polymer.

The membrane may also comprise a backing material.

Still further, the invention provides a method of separating, inorganic and organic solutes from water by nanofiltration, synthetic and naturally occurring macromolecules, proteins, colloids and emulsions from water by ultrafiltration, water from organic solvents by evaporation. It also provides a method to clean industrially occurring wastewater and surface water such as river water, whereby the contamination of membrane surface is substantially reduced. The surface contamination often leads to a significant decrease of the membrane flux, affecting adversely the operating cost of the membrane module.

### BRIEF DESCRIPTION OF THE DRAWINGS

The method of synthesis of hydrophilic surface modifying macromolecules, H-phil SMM and H-phil SMM blended membranes according to the present invention will now be described, by way of example only, reference being made to the accompanying drawings, in which:

FIG. 1 shows the schematic of the synthesis of SMM-PEG in accordance with the present invention; and

FIG. 2 shows the schematic of the synthesis of SMM-PPG.

### DETAILED DESCRIPTION OF THE INVENTION

The present invention provides a method of producing hydrophobic polymeric membrane materials having hydrophilic surfaces. The specific design of a membrane for use in particular separation is governed by many factors including relative hydrophilic/hydrophobic properties, selectivity, pore size, mechanical strength and tendency to foul. Through the modification of the chemical composition of the membrane and/or the method of preparing the membrane, specific and quantifiable surface and bulk properties can be engineered into the membrane enabling the separation or removal of specific components or contaminants in a solution. Specifically, polyethersulfone (PES), polyetherimide (PEI), polysulfone (PS) and polyvinylidene fluoride (PVDF) are membrane forming compounds which may be used as a base membrane component and whose relative hydrophobic or hydrophilic properties can be tailored through the incorporation of additives within the membranes and, in particular, through the use of hydrophilic surface modifying macromolecules (H-phil SMM) to enable effective separations. Still further, pore forming polymers, such as polyvinylpyrrolidone (PVP) can be incorporated to enhance the formation of pores within the membrane.

The structure of polyethersulfone (PES), same as poly(oxy-1,4-phenylenesulfonyl-1,4-phenylene), (Victrex 4800P, ICI Advanced Materials, Billingham, Cleveland, England) is: 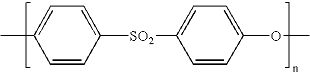
PES was used as a base membrane component. Polyvinylpyrrolidone (PVP) (average molecular weight 10 000, Sigma Chemical Co., St. Louis, Mo.) was used as a pore former. N-methyl-2-pyrrolidinone (NMP), same as 1-methyl-2-pyrrolidinone, (anhydrous 99.5%, Aldrich Chemical Company, Inc., Milwaukee, Wis.) was used as solvent.
Hydrophilic Surface Modifying Macromolecule Synthesis:

The present invention provides a synthesis of H-phil SMM's of the general formula:
C-{P₁-A-P₂-[B]ᵣ}_{q}-P₃-A-P₄-C
in which A is a hard segment component of the macromolecule and the precursor for A is a substituted or unsubstituted aromatic and/or aliphatic group having polar end groups. The precursor for Br is a soft segment polymer having polar end groups, and the precursor for C is a hydrophilic oligomer having polar end groups. P₁, P₂, P₃ and P₄ are polar linking groups formed by reaction between the respective polar end groups of the precursors for A, Br and C, r is in the range of 1-10, q is in the range of 1-3 and the molecular weight of the [B]ᵣ group is in the range of about 200 to about 6000 Dalton.

The synthesis involves reacting the hard segment precursor A having at least one polar end group, such as an isocyanate group, with a soft segment precursor polymer B such as oligomeric diol to yield a segment block oligomeric prepolymer, {P₁-A-P₂-[B]ᵣ}_{q}. This segment block oligomeric prepolymer is then reacted with one of the precursor hydrophilic oligomers C to produce the H-phil SMMs, C-{P₁-A-P₂-[B]ᵣ}_{q}-P₃-A-P₄-C.

H-phil SMM may be synthesized using a multi-functional isocyanate, a multi-functional soft segment precursor reactive therewith and a hydrophilic oligomer. More specifically, H-phil SMMs were synthesized in accordance with the following method: Methylene di-phenylene 4,4′-diisocyanate (MDI) was reacted with polypropylene glycol (PPG) of average molecular weight 425 Dalton to form a prepolymer. The prepolymer was then reacted with the end capping hydrophilic oligomer, such as polyethylene glycol (PEG) of molecular weight 200 Dalton.

The isocyanate is preferably, but not limited to be, di-functional in nature in order to favor the formation of a linear H-phil SMM. A linear H-phil SMM (as opposed to branched or cross linked H-phil SMM's) is preferred because a linear H-phil SMM will have better migration properties within a polymer substrate. A preferred diisocyanate for membrane applications is methylene di-phenylene 4,4′-diisocyanate (MDI).

The precursor for the soft segment polymer Bᵣ can be selected from any one of polypropylene oxide polyols, polytetramethylene oxide polyol, polyalkylene oxide polyol, polycarbonate polyol, polyester polyol or polycaprolactone polyol. The soft segment precursor molecule is preferably, but not limited to be, di-functional in order to favor the formation of a linear H-phil SMM. Again, linearity favors migration properties within the base polymer substrate. Examples of typical soft segment precursors include polypropylene glycol of average molecular weight 425 Dalton, and polytetramethylene oxide of average molecular weight 600 Dalton. H-phil SMM's are synthesized using a preliminary prepolymer method similar to classical one used for polyurethanes. However, subsequent steps differ in that chain extension is not carried out. A mono- or di-functional hydrophilic oligomer with active hydrogens, for example polyethylene glycol, is used to cap the prepolymer, rather than chain extends the prepolymer.

In accordance with the invention, a group of hydrophilic oligomers C that include polyols, polyalkylene amines, polyamides with one or two hydroxyl, amine or carboxyl functional groups at one or both ends of the molecules were chosen to synthesize specific polyol-urethane, polyalkylene amine-urethane and polyamide-urethane copolymers, which are designated herein as hydrophilic surface modifying macromolecules (H-phil SMM's), through urethane, amide and urea linkage. The hydrophilic oligomers are further characterized by the number of repeat units from 1 to 10. Examples of specific hydrophilic oligomers are described below in examples of the invention.

The above hydrophilic oligomers were selected on the basis of their high hydrophilicity and their ability to form a linkage with an isocyanate group. The effectiveness of H-phil SMMs in altering the surface properties of a membrane are a result of their migration toward a interface between polymer solution and the surrounding atmosphere during membrane preparation, this migration a result of the amphipathic properties of the H-phil SMM molecule. Essentially, the structure of the H-phil SMM molecule is such that the polymeric backbone of the H-phil SMM molecule remains buried in the membrane while the hydrophilic tail aligns itself with the interface thereby imparting hydrophilic properties to the membrane surface.

Membrane Preparation:

Specific membranes prepared in accordance with the invention were solution cast from a membrane preparation solution having the following composition: 10-25 wt % polyethersulfone (PES) as a base polymer; and 0-1 and 1-20 wt % polyvinylpyrrolidone (PVP) as a pore-forming polymer; and 0-1 and 1-6 wt % H-phil SMM; and, the remaining wt % a solvent such as N-methyl-2-pyrrolidinone (NMP) wherein the solvent is subsequently eliminated from the membrane by either an evaporation or a solvent exchange process or a combination of the evaporation and solvent exchange processes after casting the membrane.

An example of an H-phil SMM is synthesized with degassed polypropylene glycol (PPG) of average Mn ca. 425 (Aldrich Chemical Company, Inc., Milwaukee, Wis.), vacuum distilled methylene di-phenylene 4,4′-diisocyanate (MDI) (Eastman Kodak Company, Rochester, N.Y.), and degassed polyethylene glycol (PEG) of average molecular weight 200 (Sigma Chemical Co., St. Louis, Mo.). This enables synthesis of SMM-PEG, an H-phil SMM with a target 3:2:2 stoichiometry of MDI:PPG:PEG. The conditions of the synthesis of this reaction were as follows: 8.5 grams of PPG were reacted with 7.5 grams of MDI for 3 hours to form a prepolymer and then 4 gram of PEG were added to produce the end capping reaction. The mixture was reacted without catalyst in 200 mL of degassed N,N-dimethylacetamide (DMAc) (99+%, Aldrich Chemical Company, Inc., Milwaukee, Wis.) and the reaction temperature for the prepolymer step was maintained within 48 to 50° C. The reaction temperature for the end-capping step was also 48 to 50° C. for 24 hours.

The PES powder was dried at 150° C. in a convection oven for 4 hours before mixing. The SMM-PEG was dissolved in NMP then PES was added into the solution after SMM-PEG was completely dissolved. In some experiments, PVP was added to the SMM-PEG solution after being dried at 60° C. When PVP was incorporated it was mixed with the SMM-PEG solution prior to the addition of PES. The solution was filtered to remove undissolved polymer and contaminants and degassed to prevent pinhole formation in the cast membranes.

Membranes were cast on a glass plate to a nominal thickness of 0.02 cm. Immediately after casting, the films were gelled by immersing the glass plate into distilled water bath at room temperature. The membranes were kept in the gelation media overnight.

The membranes so obtained can be used for nanofiltration or ultrafiltration membranes.

Optimization of Base Polymer Concentration:

The base polymer concentration can be varied as is reasonable in order that the resulting membrane 1) enables the incorporation of an H-phil SMM into the base polymer and 2) provides the desired water permeation and solute exclusion properties. Practically, the weight % range of base polymer should be in the range of 10-25% of the total membrane preparation solution.

Optimization of PVP Concentration:

As indicated above, a pore forming agent can be incorporated into the membrane composition to promote the formation of pores. For PVP optimization, the PVP concentration of the casting solution was varies from 0-1 and 1-8 wt % while PES and SMM-PEG concentrations were maintained at 20 wt % and 1.5 wt %, respectively, the balance being NMP solvent. The performance of these membranes was evaluated by ultrafiltration experiments using 200 ppm PEG 4K solution as feed. The permeation flux was determined and the compositions of both feed and permeate were analyzed in terms of total carbon using a total organic carbon (TOC) analyzer. The results of the experiments are given later in the example.

Membrane Characterization Experiments:

Advancing contact angles provide an indication of the relative hydrophobicity and hydrophilicity of a surface. The higher the contact angle the more the surface is hydrophobic. The results of contact angle measurement are given in the example.

Utrafiltration Experiments:

The membrane may be used in separating organic or inorganic solutes, synthetic or naturally occurring macromolecules, proteins, colloids and emulsions from water by nanofiltration or ultrafiltration. The pore sizes of nanofiltration membranes are about 1 nm, while the pore sizes of ultrafiltration membranes are from 1 to 100 nm. Hence, nanofiltration membranes are used for the separation of smaller molecules such as electrolytes and sugars while ultrafiltration membranes are used for the separation of macromolecules and colloidal particles. In the practical membrane applications, the contamination of membrane surface occurs during the operation, which leads to a severe decrease in permeation rate. This phenomenon is called membrane fouling and the membrane economics depend largely on the degree of fouling. It is generally accepted that the fouling can be reduced by an increase in the surface hydrophilicity. Hence, the fouling of newly invented membranes with enhanced surface hydrophilicity was tested by using Ottawa river water as the feed and determining the decrease in the flux after many hours of ultrafiltration operation.

The invention will now be illustrated using the following non-limiting examples.

### EXAMPLE

H-phil SMM Synthesis:

A new surface modifying macromolecule (H-phil SMM) was synthesized by the following method. 7.5 g (0.03 moles) of vacuum distilled methylene di-phenylene 4,4′-diisocyanate (MDI) in 50 mL of degassed N,N-dimethylacetamide (DMAC) and 8.5 g (0.02 moles) of degassed polypropylene glycol (PPG) in 100 mL of DMAC were mixed in a 1 L Pyrex round bottom flask. MDI and PPG were allowed to react at 48-50° C. for 3 hours. Then, 0.02 moles of degassed polyethylene glycol (PEG) in 50 mL of degassed DMAC was added to further react with MDI for 24 hours at 48-50° C. Not wishing to be bound by any theory, it is believed that the resulting polymer is end-capped by PEG. The solution was added drop-wise to distilled water under vigorous stirring to precipitate the polymer. The polymer was kept in distilled water under stirring for 24 hours in order to leach out residual solvent. Then, the polymer was separated from the water by filtration and placed in an oven with forced air circulation at 50° C. for 5 days. The weight of polymer was approximately 10 g. The SMM-PEG was stored in a glass bottle wrapped with aluminum foil, which was placed in a dessicator.

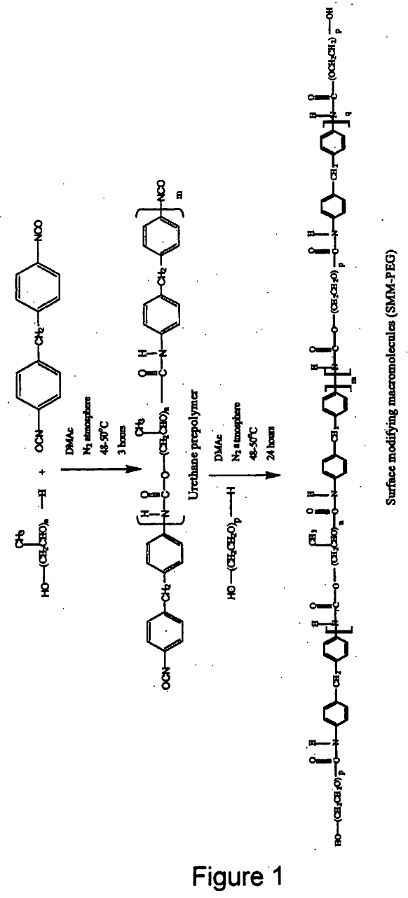

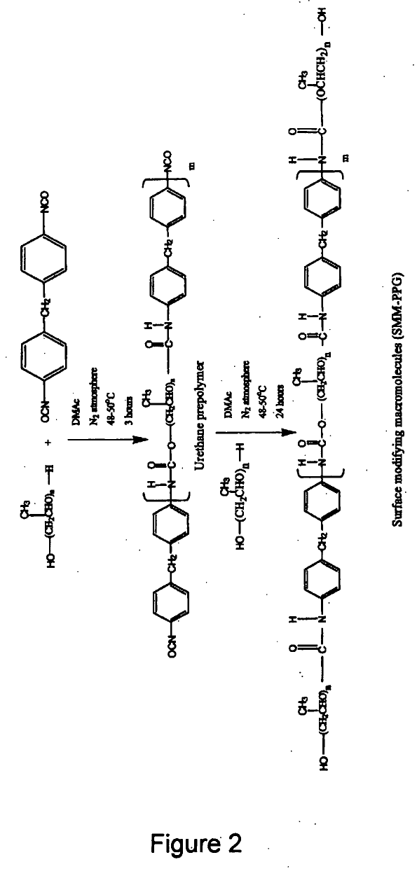

Depending on the average molecular weight of PEG (200, 400, 600, and 1000) the resulting polymers are called SMM-PEG-200, SMM-PEG-400, SMM-PEG-600, and SMM-PEG-1000, respectively. The schematic of the synthesis of SMM-PEG [Polyethylene glycol both ends capped poly(4,4′-diphenylenemethylene propylene-urethane)-co-poly(4,4′-diphenylenemethylene ethylene-urethane)] is given in FIG. 1. Similarly, SMM end-capped by polypropylene glycol (PPG) was synthesized. This polymer is hereafter called SMM-PPG-425 [Polypropylene glycol both ends capped poly(4,4′-methylenediphenylene propylene-urethane)], since PPG of average molecular weight 425 was used. The schematic of the synthesis of SMM-PPG is given also in FIG. 2.

H-phil SMM Characterization:

Nitrogen contents in SMM-PEG-200 and SMM-PPG-425 were 5.92 and 4.94 wt %, respectively. The molecular weights measured by gel permeation chromatography were 7.43×10⁴ Dalton, 5.42×10⁴ Dalton, 2.92×10⁴ Dalton and 6.21×10⁴ Dalton, for SMM-PEG-200, SMM-PEG-400, SMM-PEG-600, and SMM-PEG-1000, respectively. The molecular weight was 1.35×10⁴ Dalton for SMM-PPG-425.

The presence of hydroxyl group in the SMMs was confirmed by NMR.

Contact Angle Measurement:

Polymer solution was prepared by dissolving 20 wt % polyethersulfone (PES) in N-methyl-2-pyrrolidinone (NMP). The solution was cast to a thickness of 0.2 mm. Immediately after casting, the membrane together with the glass plate were immersed into a gelation bath containing distilled water. Similarly, membranes were prepared from PES/SMM-PEG-200 blends and SMM-PEG-200. The contact angle was measured for each film. The results are summarized in Table 1.

TABLE 1
Results of contact angle measurement

| SMM-PEG-200 content | |
|---|---|
| in PES film, wt % | Contact angle, degree |
| SMM-PEG-200 0% | 68.1 ± 1.1 |
| SMM-PEG-200 1.5% | 65.2 ± 1.2 |
| SMM-PEG-200 3% | 61.8 ± 1.4 |
| SMM-PEG-200 6% | 60.6 ± 2.8 |
| SMM-PEG-200 12% | 57.0 ± 2.3 |
| SMM-PEG-200 100% | 66.5 ± 1.3 |

Table 1 shows that the contact angle of the PES film decreased by blending SMM-PEG-200. The contact angle kept decreasing as the amount of SMM-PEG-200 in the polymer blend was increased. Interestingly, the contact angles of PES/SMM-PEG-200 blended films were less than that of SMM-PEG-200 film. This suggests that the polyethylene glycol groups at both ends of SMM-PEG-200 were oriented towards water at the water/polymer interface, while polyurethane chain is buried in the base PES polymer.

The membranes were prepared from pure SMM-PEG and PES/SMM-PEG blends with different PEG molecular weights. The results of the contact angle measurement are shown in Table 2.

TABLE 2
Comparison of contact angles of SMM-PEG with PEG of different
molecular weights and contact angle of SMM-PPG-425

| Membrane^{a} | Pure SMM | 1.5 wt % SMM | 3.0 wt % SMM |
|---|---|---|---|
| SMM-PEG-200 | 66.5 ± 1.3 | 65.2 ± 1.2 | 61.8 ± 1.4 |
| SMM-PEG-400 | 72.1 ± 2.2 | 64.2 ± 3.3 | 63.2 ± 3.1 |
| SMM-PEG-600 | 70.6 ± 1.8 | 67.1 ± 2.3 | 64.2 ± 3.5 |
| SMM-PEG-1000 | 68.3 ± 2.0 | 65.7 ± 1.6 | 65.4 ± 1.4 |
| SMM-PPG-425 | 68.0 ± 1.5 | 65.4 ± 1.4 | 63.6 ± 2.6 |

^{a}Contact angle of pure PES membrane 68.1 ± 1.1

The contact angles of the SMM-PEG membranes are lower than pure PES and SMM membranes and decrease as the SMM content increases. The change in the contact angles seems relatively small, particularly when compared to many commercial hydrophilic composite membranes that have significantly smaller contact angles.

Membrane Preparation:

PES was dissolved in NMP to prepare 20 wt % PES solution. The solution was cast on a glass plate to 0.2 mm thickness, before the solution film together with the glass plate was immersed to a gelation bath containing distilled water. The membrane peeled off the glass plate spontaneously. Similarly, a PES/SMM-PEG or PES/SMM-PPG blend membrane was prepared from a solution containing both PES (20 wt %) and a specified amount of SMM-PEG or SMM-PPG. In some experiments, a specified amount of PVP was also added.

Ultrafiltration Tests:

The membranes so prepared were tested for their ultrafiltration performance at 25° C. and 50 psig. Prior to the ultrafiltration tests, all membranes were pressurized under distilled water at 80 psig for 1 hour. The membranes were then kept at 50 psig for another 4-5 hours until the permeation rate became steady. From each ultrafiltration experiment, pure water permeation flux, permeation flux in the presence of solute, and solute separation defined as (feed solute concentration−permeate solute concentration)/(feed solute concentration) were obtained. Polyethylene glycols (molecular weight below or equal to 35 kDalton) and polyethylene oxides (molecular weight above 35 kDalton) were used as solutes. The concentration of the solute in the feed solution was 200 ppm. The analysis of polyethylene glycol and polyethylene oxide was done by Total Organic Carbon (TOC) analyzer.

Table 3 shows ultrafiltration data of a PES membrane that was prepared without blending either SMM-PEG or SMM-PPG or PVP. PEGs of different molecular weights were used as solutes in the feed solution. Table 4a shows ultrafiltration data of PES/SMM-PEG-200 membrane in which 3 wt % of SMM-PEG-200 was blended.

TABLE 3
Results of ultrafiltration experiments for PES membrane

| Solute | Flux (L/m²h) | Separation (%) |
|---|---|---|
| (Pure water experiment) | 139.89 ± 42.19 | |
| PEG 20K | 41.65 ± 5.59 | 2.31 ± 0.64 |
| PEG 35K | 29.28 ± 4.88 | 8.78 ± 8.87 |
| PEO 100K | 9.39 ± 1.34 | 67.98 ± 4.78 |
| PEO 200K | 7.31 ± 1.17 | 78.05 ± 1.32 |
| PEO 300K | 5.40 ± 0.90 | 80.19 ± 2.73 |

TABLE 4a
Results of ultrafiltration experiments for PES/SMM-PEG-200 (3 wt %)
blend membrane

| Solute | Flux (L/m²h) | Separation (%) |
|---|---|---|
| (Pure water experiment) | 14.37 ± 7.35 | |
| PEG 1.5K | 12.68 ± 8.07 | 51.01 ± 11.07 |
| PEG 4K | 11.76 ± 7.34 | 81.43 ± 5.50 |
| PEG 10K | 12.09 ± 7.38 | 92.48 ± 4.86 |
| PEG 20K | 12.15 ± 7.47 | 93.11 ± 3.38 |
| PEG 35K | 13.30 ± 7.21 | 98.81 ± 1.14 |

From Table 3, PES membrane without SMM-PEG blending had a molecular weight cut-off (MWCO) above 300 kDalton. The flux decreased as the molecular weight of the solute (PEO) increased, indicating the severe pore blocking exercised by the macromolecular solutes. The MWCO decreased dramatically by blending 3 wt % SMM-PEG-200 to below 10 kDalton (Table 4a).

The initial pure water flux decreased to about one tenth by blending the SMM-PEG-200. The permeation flux in the presence of PEG solute did not change when the solute (PEG) molecular weight was increased.

TABLE 4b
Ultra-filtration results of PES/SMM-PEG-400 membranes

| | 1.5 wt % SMM^{a} | | 3.0 wt % SMM^{a} | |
|---|---|---|---|---|
| | Flux (L/m²h) | Separation (%) | Flux (L/m²h) | Separation (%) |
| Pure water | 21.22 ± 4.85 | | 70.15 ± 7.72 | |

Ultra-filtration results with solute

| | | | | |
|---|---|---|---|---|
| PEG 4K | 23.58 ± 4.92 | 16.03 ± 4.83 | 67.57 ± 6.27 | 20.34 ± 2.96 |
| PEG 20K | 21.60 ± 3.19 | 31.64 ± 3.50 | 64.11 ± 5.33 | 41.17 ± 3.48 |
| PEG 35K | 17.08 ± 4.08 | 72.79 ± 2.68 | 48.06 ± 3.40 | 76.33 ± 1.31 |
| PEG 100K | 13.36 ± 2.96 | 94.25 ± 1.97 | 40.22 ± 2.49 | 96.88 ± 0.13 |
| PEG 300K | 11.26 ± 2.14 | 98.05 ± 0.44 | 33.89 ± 3.11 | 99.30 ± 0.48 |

^{a}wt % of SMM-PEG-400 in the casting solution

TABLE 4c
Ultra-filtration results of PES/SMM-PEG-1000 membranes

| | 1.5 wt % SMM^{a} | | 3.0 wt % SMM^{a} | |
|---|---|---|---|---|
| | Flux (L/m²h) | Separation (%) | Flux (L/m²h) | Separation (%) |
| Pure water | 65.58 ± 3.67 | | 74.83 ± 6.06 | |

Ultra-filtration results with solute

| | | | | |
|---|---|---|---|---|
| PEG 4K | 45.60 ± 2.31 | 76.15 ± 0.39 | 80.90 ± 5.63 | 77.01 ± 3.50 |
| PEG 20K | 34.28 ± 4.22 | 90.46 ± 0.22 | 69.27 ± 4.41 | 90.70 ± 1.24 |
| PEG 35K | 25.46 ± 2.28 | 99.17 ± 0.06 | 57.08 ± 2.95 | 98.69 ± 0.67 |
| PEG 100K | 19.37 ± 1.48 | 99.22 ± 0.26 | 47.92 ± 2.36 | 99.04 ± 0.32 |
| PEG 300K | 16.87 ± 1.84 | 99.42 ± 0.04 | 43.12 ± 1.44 | 100.00 ± 0.00 |

^{a}wt % of SMM-PEG-1000 in the casting solution

TABLE 4d
Ultra-filtration results of PES/SMM-PPG-425 membranes

| | 1.5 wt % SMM^{a} | | 3.0 wt % SMM^{a} | |
|---|---|---|---|---|
| | Flux (L/m²h) | Separation (%) | Flux (L/m²h) | Separation (%) |
| Pure water | 30.16 ± 2.82 | | 86.02 ± 3.88 | |

Ultra-filtration results with solute

| | | | | |
|---|---|---|---|---|
| PEG 4K | 28.83 ± 2.53 | 42.22 ± 1.18 | 83.48 ± 2.77 | 54.99 ± 0.52 |
| PEG 20K | 27.34 ± 3.45 | 68.14 ± 1.57 | 78.28 ± 1.97 | 76.02 ± 0.18 |
| PEG 35K | 26.51 ± 1.36 | 85.68 ± 1.61 | 64.15 ± 1.33 | 85.93 ± 0.52 |
| PEG 100K | 24.19 ± 2.25 | 94.41 ± 1.36 | 54.98 ± 1.25 | 95.22 ± 0.13 |
| PEG 300K | 22.43 ± 2.40 | 98.89 ± 0.26 | 46.82 ± 1.40 | 98.68 ± 0.11 |

^{a}wt % of SMM-PPG-425 in the casting solution

The results of UF experiments are also shown in Table 4b-d for SMM-PEG-400, SMM-PEG-1000, and SMM-PPG-425 membranes, respectively. The effect of the concentration of SMM in the casting solutions is shown in the above tables. From the tables, solute separations of membranes prepared from casting solution with 3.0 wt % of SMM are greater than those of membranes prepared from casting solution with 1.5 wt % of SMM.

Table 5 shows still further ultrafiltration experimental results obtained from PES membranes into which 1.5 wt % of SMM-PEG-200 was blended. The table also includes data from PES membranes where 1.5 wt % of SMM-PEG-200 and 6.67 wt % of PVP were blended. Ultrafiltration experiments were conducted using PEG 4K as a solute in the feed solution.

The Table 5 also shows that blending PVP increases the flux.

TABLE 5
Comparison of data obtained from PES membrane, PES/SMM-PEG-200
membrane and PES/SMM-PEG-200/PVP membrane^{a}

| | | |
|---|---|---|
| Experiment | | |
| number | Flux (L/m² h) | Separation (%) |

PES membrane

| | | |
|---|---|---|
| 1 | 74.02 | 78.21 |

PES/SMM-PEG-200 membrane^{b}

| | | |
|---|---|---|
| 2^{d} | 78.31 | 84.29 |
| 3^{d} | 73.11 | 88.99 |
| 4^{d} | 55.64 | 86.59 |
| 5^{d} | 86.35 | 82.57 |

PES/SMM-PEG-200/PVP membrane^{c}

| | | |
|---|---|---|
| 6^{d} | 109.96 | 79.20 |
| 7^{d} | 91.37 | 77.6 |

^{a}PEG 4K was used as a solute in the feed solution.
^{b}1.5 wt % of SMM-PEG-200 was blended.
^{c}1.5 wt % of SMM-PEG-200 and 6.67 wt % of PVP were blended.
^{d}Experiments were repeated using SMM-PEG-200 synthesized at different times.

Treatment of Ottawa River Water:

Ottawa river water was treated by PES and PES/SMM-PEG-200 (3 wt %) membrane and the results reported in Tables 6 and 7, respectively.

TABLE 6
Results of Ottawa river water treatment by PES membrane

| | | | River water | River water |
|---|---|---|---|---|
| | Pure water | River water | UV | TOC |
| | flux (L/m²h) | flux (L/m²h) | separation (%) | separation (%) |
| 0 hr | 20.85 ± 3.72 | 18.05 ± 3.26 | 22.38 ± 3.83 | 16.24 ± 4.30 |
| 1 hr | 20.41 ± 3.74 | 17.42 ± 2.99 | 30.77 ± 3.73 | 23.16 ± 4.01 |
| 5 hrs | 18.37 ± 3.89 | 14.05 ± 2.61 | 48.25 ± 1.96 | 41.15 ± 9.77 |
| 10 hrs | 16.64 ± 4.18 | 11.43 ± 2.37 | 50.35 ± 3.55 | 36.55 ± 12.72 |
| 25 hrs | 14.27 ± 3.63 | 7.25 ± 2.07 | 56.64 ± 1.83 | 44.01 ± 10.98 |
| 50 hrs | 12.69 ± 3.70 | 3.23 ± 0.96 | 60.14 ± 4.22 | 53.54 ± 5.45 |

TABLE 7
Results of Ottawa river water treatment by PES/SMM-PEG-200 (3 wt %)
membrane

| | | | River water | River water |
|---|---|---|---|---|
| | Pure water | River water | UV | TOC |
| | flux (L/m²h) | flux (L/m²h) | separation (%) | separation (%) |
| 0 hr | 12.44 ± 7.86 | 12.03 ± 8.17 | 78.50 ± 9.13 | 79.24 ± 9.85 |
| 1 hr | 12.27 ± 7.89 | 11.90 ± 8.22 | 80.50 ± 14.45 | 84.54 ± 5.54 |
| 5 hrs | 11.98 ± 7.93 | 11.85 ± 8.34 | 80.00 ± 12.00 | 73.06 ± 7.38 |
| 10 hrs | 12.04 ± 8.06 | 11.65 ± 8.31 | 79.50 ± 9.69 | 86.98 ± 8.80 |
| 25 hrs | 11.96 ± 8.05 | 11.63 ± 8.34 | 82.50 ± 14.14 | 77.23 ± 7.53 |
| 50 hrs | 11.99 ± 8.10 | 11.60 ± 8.22 | 86.00 ± 12.29 | 81.60 ± 6.82 |
| 75 hrs | 12.03 ± 8.17 | 11.55 ± 7.73 | 86.50 ± 9.61 | 90.11 ± 10.04 |
| 100 hrs | 11.84 ± 8.12 | | | |

In Table 6, the pure water flux at time zero was far lower than the very initial pure water flux of 139.89 L/m² h (Table 3) because the data in Table 6 were obtained after the experiments with PEO solutes were completed. The initial pure water flux could not be recovered even after thorough washing of the membrane with distilled water. Moreover, both pure water flux and river water flux decreased with an increase in the duration of the experiment. After 50 hours of operation, the flux of river water went down to 3.23 L/m² h. On the other hand, in Table 7, the pure water permeation flux was almost the same as the very initial pure water flux and did not change very much as the duration of the experiment increased up to 100 hours. The solute separation was significantly higher for the SMM-PEG-200 blended membrane. Therefore, it can be concluded that both stability in membrane flux and the solute separation were improved dramatically by blending the new SMM-PEG-200 in the PES membrane. Therefore, membrane fouling is reduced by increasing the surface hydrophilicity while the membrane flux stability is improved by making the surface hydrophilicy permanent.

For a separate batch of experiments, the flux and separation were measured after 50 hrs of filtration of the Ottawa river water for PES/SMM-PEG-400 and PES/SMM-PEG-600 membranes prepared from the casting solutions of 18 wt % PES with three different (1.5 wt %, 3.0 wt %, and 4.5 wt %) SMM-PEG concentrations in the NMP solvent. The results are shown in Table 8.

TABLE 8
Flux (L/m²h) data after long term treatment of the Ottawa river
water by PES/SMM-PEG-400 and PES/SMM-PEG-600 membranes

| | | |
|---|---|---|
| SMM-PEG (wt %) | Flux (L/m² h) | Separation (%) |

PES/SMM-PEG-400 membrane^{a}

| | | |
|---|---|---|
| 1.5 | 49.37 ± 2.56 | 70.30 ± 0.40 |
| 3.0 | 48.69 ± 2.37 | 70.30 ± 0.87 |
| 4.5 | 55.72 ± 0.72 | 66.92 ± 1.58 |

PES/SMM-PEG-600 membrane^{a}

| | | |
|---|---|---|
| 1.5 | 54.10 ± 5.15 | 68.68 ± 0.40 |
| 3.0 | 51.60 ± 2.07 | 70.18 ± 0.87 |
| 4.5 | 49.95 ± 2.59 | 69.72 ± 0.24 |

^{a}18 wt % PES in the casting solution

When Table 8 is compared with Tables 6 and 7, a remarkable increase in flux is observed. It should be noted that the separations based on TOC data are about 70% by the membranes PES/SMM-PEG-400 and PES/SMM-PEG-600 which are greater than the PES membrane and about 10% lower than the PES/SMM-PEG-200 membrane. Therefore, it can be concluded that PES/SMM-PEG-400 and PES/SMM-PEG-600 membranes are far superior to PES/SMM-PEG-200 membranes.

Increase in surface hydrophilicity has been attempted by membrane surface coating, grafting hydrophilic macromolecules on the surface, surface plasma treatment etc. All conventional methods need an extra step of surface modification. According to the invention, another step for the surface treatment is not necessary since surface modification occurs by the migration of H-phil SMM to the membrane surface while casting the membrane.

It is also known that blending of hydrophilic additive such as poly(vinyl pyrrolidone) (PVP) in PES polymer makes the membrane more hydrophilic. However, PVP is soluble in water and will be eventually leached out during the ultrafiltration operation. The new H-phil SMM is so designed that the more hydrophobic part (polyurethane part) of SMM is dissolved in the host PES polymer, thus anchoring H-phil SMM permanently in the host PES membrane. This results in a long term stability in membrane flux.

Development of Membranes for Dehumidification of Air and Natural Gas

Acting as a macromolecular surfactant the newly developed H-phil SMM will increase the area of contact between water and membrane polymer. Thus, dispersion of small water droplets inside the membrane is also expected. This enables immobilization of enzymes by the formation of reversed micelles. Drugs being contained in the reversed micelles, H-phil SMM blended membranes can also be applied for drug release.

As used herein, the terms “comprises”, “comprising”, “including” and “includes” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

1) T. Matsuura, P. Santerre, R. M. Narbaitz, V. A. Pham, Y. Fang, H. Mahmud and F. Baig, U.S. Pat. No. 5,954,966 (1999)
2) Y. W. Tang, J. P. Santerre, R. S. Labow and D. G. Taylor, J. Appl. Polym. Sci., 62 (1996) 1133-1145.
3) Y. W. Tang, J. P. Santerre, R. S. Labow and D. G. Taylor, Biomaterials 18 (1997) 37-45.
4) Y. W. Tang, J. P. Santerre, R. S. Labow and D. G. Taylor, J. Biomed. Mater. Res. 35 (1997) 371-381.
5) J. Y. C. Ho, The Effect of Surface Modifying Macromolecules on the Blood Compatibility of Polyethersulfone Membrane Intended for Biomedical Applications”, M.A.Sc. Thesis, Department of Chemical Engineering and Applied Chemistry, University of Toronto, 1997.
6) A. Hamza, V. A. Pham, T. Matsuura and J. P. Santerre, J. Membrane Sci., 131 (1997) 217-227.
7) D. E. Suk, Comprehensive Exam Report, Department of Chemical Engineering, University of Ottawa, 2000.
8) D. E. Suk, G. Chowdhury, T. Matsuura, R. M. Narbaitz, P. Santerre, G. Pleizier and Y. Deslandes, Macromolecules, 35 (2002) 3017-3021.
9) D. E. Suk, G. Pleizier, Y. Deslandes and T. Matsuura, Desalination, 149 (2002) 303-307.
10) M. Khayet, G. Chowdhury and T. Matsuura, AlChE J., 48 (2002) 2833-2843.
11) M. Khayet, C. Y. Feng and T. Matsuura, J. Membrane Sci., 213 (2003) 159-180.
12) L. Zhang, G. Chowdhury, C. Feng, T. Matsuura and R. Narbaitz, J. Appl. Polym. Sci., 88 (2003) 3132-3138.
13) M. Khayet, D. E. Suk, R. M. Narbaitz, J. P. Santerre and T. Matsuura, J. Appl. Polym. Sci., 89 (2003) 2902-2916.
14) D. H. K. Pan and W. M. Prest Jr., J. Appl. Phys., 58 (1985) 2861-2870.
15) Q. S. Bhatia, D. H. Pan and J. T. Koberstein, Macromolecules, 21 (1988) 2166-2175.
16) H. R. Thomas and J. J. O'Malley, Macromolecules, 12 (1979) 323-329.
17) J. J. O'Malley, H. R. Thomas and G. M. Lee, Macromolecules, 12 (1979) 996-1001.
18) J. J. Schmidt, J. A. Gardella Jr. and L. Salvati Jr., Macromolecules, 22 (1989) 4489-4495.

1. A macromolecule having a general formula:
C-{P₁-A-P₂-[B]ᵣ}_{q}-P₃-A-P₄-C
wherein a precursor for A is a hard segment component of the macromolecule and is a substituted or unsubstituted aromatic and/or aliphatic group having polar end groups, the precursor for [B]ᵣ is a soft segment polymer having polar end groups, the precursor for C is a hydrophilic oligomer having polar end groups, P₁, P₂, P₃ and P₄ are polar linking groups formed by reaction between the respective polar end groups of the precursor for A, Br and C, r is in a range of 1 to 10, q is in a range of 1 to 3 and a molecular weight of the [B]ᵣ group is in a range from about 200 to about 6000 Dalton.

2. The macromolecule according to claim 1 wherein the precursor for the substituted or unsubstituted aromatic and/or aliphatic group A has polar end groups selected from the group consisting of isocyanate, hydroxy, amine, carboxylic acid and combinations thereof, and wherein the precursor for the soft segment polymer Bᵣ has polar end groups selected from the group consisting of hydroxy and amine groups.

3. The macromolecule according to claim 1 wherein the precursor for the soft segment polymer Bᵣ is selected from the group consisting of polypropylene oxide polyols, polytetramethylene oxide polyol, polyalkylene oxide polyol, polycarbonate polyol, polyester polyol and polycaprolactone polyol.

4. The macromolecule according to claim 2 wherein the precursor for the substituted or unsubstituted aromatic and/or aliphatic group A having isocyanate polar end groups are selected from the group consisting of methylene di-phenylene 4,4′-diisocyanate (MDI), toluene 2,4-diisocyanate, toluene 2,6-diisocyanate, cyclohexane 1,4-diisocyanate, methylene di-cyclohexane 4,4′-diisocyanate and hexane 1,6-diisocyanate.

5. The macromolecule according to claim 1 wherein the hydrophilic oligomer C is selected from the group consisting of polyols, polyalkylene amines, aromatic polyamides and aliphatic polyamides having polar end groups selected from the group consisting of hydroxyl, carboxy, amine and combinations thereof.

6. The macromolecule according to claim 5 wherein the hydrophilic oligomer are characterized by the number of repeat units from 1 to 10.

7. The macromolecule according to claim 5 wherein the hydrophilic oligomer C is selected from the group consisting of polyethylene glycol, polyethylenimine, and 1,4-phenylene diamine, phthalic acid copolymer.

8. A macromolecule having a formula (I) 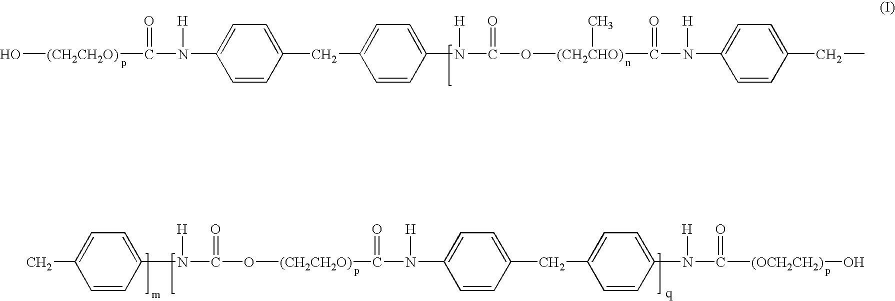
poly(4,4′-diphenylenemethylene propylene-urethane)-co-poly(4,4′-diphenylene methylene ethylene-urethane) both ends capped by polyethylene glycol.

9. The macromolecule (I) according to claim 8 made by a method comprising the steps of:
reacting methylene di-phenylene 4,4′-diisocyanate (MDI) with polypropylene glycol (PPG) to form a segment blocked oligomeric prepolymer which is poly(4,4′-diphenylenemethylene propylene-urethane) having both ends capped with isocyanate; and
reacting the segment blocked oligomeric prepolymer with polyethylene glycol (PEG) to give poly(4,4′-diphenylenemethylene propylene-urethane)-co-poly(4,4′-diphenylene methylene ethylene-urethane) both ends capped with polyethylene glycol.

10. The method according to claim 9 wherein a molar ratio of MDI:PPG:PEG is maintained at about 3:2:2.

11. A macromolecule having a formula (II) 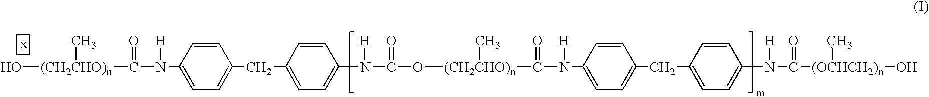
which is poly(4,4′-diphenylenemethylene propylene-urethane) having both ends capped with polypropylene glycol.

12. The macromolecule (II) according to claim 11 made by a method comprising the steps of:
reacting methylene di-phenylene 4,4′-diisocyanate (MDI) with polypropylene glycol (PPG) to form a segment blocked oligomeric prepolymer which is poly(4,4′-diphenylenemethylene propylene-urethane) having both ends capped with isocyanate; and
reacting the segment blocked oligomeric prepolymer with polypropylene glycol (PPG) to give poly(4,4′-diphenylenemethylene propylene-urethane) having both ends capped with polypropylene glycol.

13. The method according to claim 12 wherein a molar ratio of MDI:PPG is maintained at 3:4.

14. A macromolecule having a general formula:
C-{P₁-A-P₂-[B]ᵣ}_{q}-P₃-A-P₄-C
wherein A is a hard segment component of the macromolecule and is a substituted or unsubstituted aromatic and/or aliphatic group, [B]ᵣ is a soft segment polymer, C is a hydrophilic oligomer, P₁, P₂, P₃ and P₄ are polar linking groups, r is in a range from 1 to 10, q is in a range from 1 to 3 and a molecular weight of the [B]ᵣ is in a range from about 200 to about 6000 Dalton.

15. A method of synthesizing a macromolecule (I) of the general formula: C-{P₁-A-P₂-[B]ᵣ}_{q}-P₃-A-P₄-C, wherein A is a hard segment component of the macromolecule and is a substituted or unsubstituted aromatic and/or aliphatic group, P₁, P₂, P₃ and P₄ are polar linking groups, [B]ᵣ is a soft segment polymer, C is a hydrophilic oligomer, r is in a range of 1 to 10, q is in a range of 1 to 3 and a molecular weight of the [B]ᵣ group is in the range of about 200 to about 6000, the method comprising the steps of:
synthesizing a segmented block oligomeric copolymer {P₁-A-P₂-[B]ᵣ}_{q}, by reacting a substituted or unsubstituted aromatic and/or aliphatic having end isocyanate, hydroxy, amine or carboxylic acid groups with an oligomeric diol having end hydroxy or amine groups to form a urethane, amide, ester or urea linkage; and
reacting the segmented block oligomeric copolymer with a hydrophilic oligomer to end cap the segmented block oligomeric copolymer to produce macromolecule (I).

16. The method of synthesizing a macromolecule (I) according to claim 15 wherein the oligomeric diol is selected from the group consisting of polypropylene oxide polyols, polytetramethylene oxide polyol, polyalkylene oxide polyol, polycarbonate polyol, polyester polyol and polycaprolactone polyol.

17. The method of synthesizing a macromolecule (I) according to claim 15 wherein the hydrophilic oligomers are selected from the group consisting of polyols, polyalkylene amines, aliphatic polyamides, aromatic polyamides with one or two hydroxyl, amine or carboxylic functional groups.

18. The method of synthesizing a macromolecule (I) according to claim 15 wherein when a precursor for A has an isocyanate end, the isocyanate is selected from the group consisting of methylene di-phenylene 4,4′-diisocyanate (MDI), toluene 2,4-diisocyanate, toluene 2,6-diisocyanate, cyclohexane 1,4-diisocyanate, methylene di-cyclohexane 4,4′-diisocyanate or hexane 1,6-diisocyanate.

19. A method of synthesizing a hydrophilic surface modifying macromolecule (H-phil SMM), comprising the steps of:
reacting a multi-functional isocyanate with an oligomeric diol to form a segment block oligomeric prepolymer; and
reacting the oligomeric prepolymer with a hydrophilic oligomer to end cap the oligomeric prepolymer to produce a hydrophilic surface modifying macromolecule (H-phil SMM).

20. The method according to claim 19 wherein the isocyanate is di-functional, and wherein the oligomeric diol is di-functional, and wherein the hydrophilic oligomer is a mono- or di-functional hydrophilic oligomer with active hydrogens in order to favor formation of a linear H-phil SMM.

21. The method according to claim 20 wherein the isocyanate is selected from the group consisting of methylene di-phenylene 4,4′-diisocyanate (MDI), toluene 2,4-diisocyanate, toluene 2,6-diisocyanate, cyclohexane 1,4-diisocyanate, methylene di-cyclohexane 4,4′-diisocyanate and hexane 1,6-diisocyanate.

22. The method according to claim 19 wherein the oligomeric diol is selected from the group consisting of polypropylene oxide polyols, polytetramethylene oxide polyol, polyalkylene oxide polyol, polycarbonate polyol, polyester polyol and polycaprolactone polyol.

23. The method according to claim 22 wherein the multi-functional isocyanate is methylene di-phenylene 4,4′-diisocyanate (MDI) and the oligomeric diol is polypropylene glycol (PPG), and wherein the hydrophilic oligomer is polyethylene glycol (PEG).

24. The method according to claim 23 wherein the polypropylene glycol (PPG) has an average molecular weight of about 425 Dalton, and wherein the polyethylene glycol (PEG) has a molecular weight of about 200 Dalton.

25. The method according to claim 22 wherein the hydrophilic oligomers are selected from the group consisting of polyols, polyalkylene amines, aliphatic polyamides, aromatic polyamides with one or two hydroxyl, amine or carboxylic functional groups.

26. A membrane, comprising:
a) between about 10 to about 25 wt % of a hydrophobic base polymer miscible with a macromolecule mixed therewith, the macromolecule having a general formula C-{P₁-A-P₂-[B]ᵣ}_{q}-P₃-A-P₄-C, wherein A is a hard segment component of the macromolecule and is a substituted or unsubstituted aromatic and/or aliphatic group, [B]ᵣ is a soft segment polymer, C is a hydrophilic oligomer, P₁, P₂, P₃ and P₄ are polar linking groups, r is in a range from 1 to 10, q is in a range from 1 to 3 and a molecular weight of the [B]ᵣ is in a range from about 200 to about 6000 Dalton; and
b) between about 0 to about 20 wt % of a hydrophilic pore forming polymer miscible with the base polymer and 49-90 wt % of a solvent, the solvent being subsequently eliminated from the membrane by either an evaporation or a solvent exchange process or a combination of the evaporation and solvent exchange process.

27. The membrane according to claim 26 wherein the precursor for the substituted or unsubstituted aromatic and/or aliphatic group A has polar end groups selected from the group consisting of isocyanate, hydroxy, amine, carboxylic acid and combinations thereof, and wherein the precursor for the soft segment polymer B has polar end groups selected from the group consisting of hydroxy, amine groups and combinations thereof.

28. The membrane according to claim 27 wherein the precursor for the substituted or unsubstituted aromatic and/or aliphatic group A having isocyanate polar end groups are selected from the group consisting of methylene di-phenylene 4,4′-diisocyanate (MDI), toluene 2,4-diisocyanate, toluene 2,6-diisocyanate, cyclohexane 1,4-diisocyanate, methylene di-cyclohexane 4,4′-diisocyanate and hexane 1,6-diisocyanate.

29. The membrane according to claim 26 wherein the precursor for the soft segment polymer [B]ᵣ is selected from the group consisting of polypropylene oxide polyols, polytetramethylene oxide polyol, polyalkylene oxide polyol, polycarbonate polyol, polyester polyol and polycaprolactone polyol.

30. The membrane according to claim 26 wherein the precursor for the hydrophilic oligomer C is selected from the group consisting of polyols, polyalkylene amines, aromatic polyamides and aliphatic polyamides having polar end groups selected from the group consisting of hydroxyl, carboxy, amine and combinations thereof.

31. The membrane according to claim 26 wherein the precursor for the hydrophilic oligomer C is selected from the group consisting of polyethylene glycol, polyethylenimine, and 1,4-phenylene diamine, phthalic acid copolymer.

32. The membrane according to claim 30 wherein the hydrophilic oligomer C is characterised by a number of repeat units in a range from 1 to 10.

33. The membrane according to claim 26 wherein the base polymer is selected from the group consisting of polyethersulfones, polyureas, polyetherimides, polyesters, polyurethanes, polycarbonates, polyvinylidene fluoride, and combinations thereof.

34. The membrane according to claim 26 wherein the pore forming polymer is selected from the group consisting of polyvinylpyrrolidone (PVP), ethylene glycol, alcohols, polyethylene glycol, and combinations thereof.

35. The membrane according to claim 26 wherein the macromolecule has a formula (I) 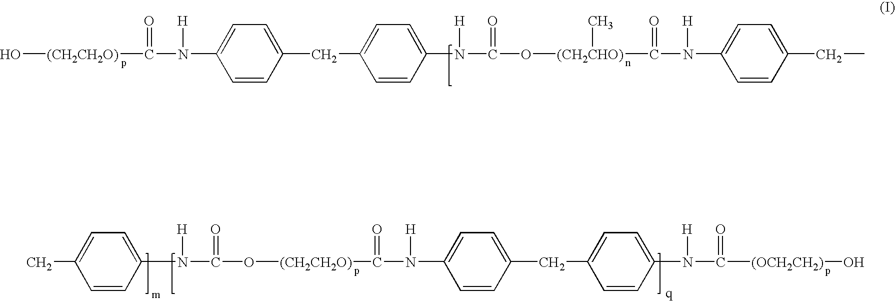
which is poly(4,4′-diphenylenemethylenepropylene-urethane)-co-poly(4,4′-diphenylene methylene ethylene-urethane) both ends capped by polyethylene glycol.

36. The membrane according to claim 26 wherein the macromolecule has a formula (II) 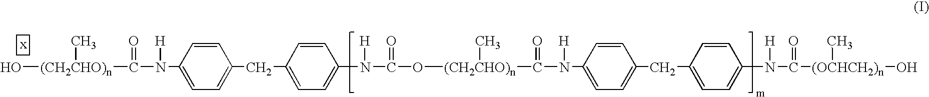
which is poly(4,4′-diphenylenemethylene propylene-urethane) both ends capped by polypropylene glycol.
